(19) United States
(12) Patent Application Publication
(10) Pub. No.: US 2005/0151513 A1
(43) Pub. Date: Jul. 14, 2005

(54) Vehicle power and battery management system

(76) Inventors: Alexander Cook, Dublin, OH (US); Philip Warwick Irwin, Dublin, OH (US)

Correspondence Address: ELEY LAW FIRM CO., 7870 OLENTANGY RIVER RD, SUITE 311, COLUMBUS, OH, 43235, US

(21) Appl. No.: 11/035,609

(22) Filed: Jan. 14, 2005

Related U.S. Application Data
(60) Provisional application No. 60/536,328, filed on Jan. 14, 2004.

(51) Int. Cl. H02J 7/14

(52) U.S. Cl. 320/137

(57) ABSTRACT

A vehicle power and battery management system. The system includes a high-voltage DC bus, a first battery, a second battery, at least one bidirectional DC/DC converter, and a controller. The controller monitors the state of at least one of the high-voltage bus, the first battery and the second battery, and transfers energy between at least two of the high-voltage bus, first battery and second battery with the bidirectional DC/DC converter. A method employs the system.

This application claims priority to U.S. provisional application 60/536,328, filed Jan. 14, 2004, the contents of which are hereby incorporated by reference.

### FIELD

The present invention relates generally to vehicle electrical systems and, more particularly, to a system for managing charge and discharge of a plurality of batteries of a vehicle.

### BACKGROUND

There are increasing demands on the electrical systems of vehicles, such as multiple power sources, loads with differing priorities and criticalities, and differing voltage requirements. The increased complexity of such electrical systems requires a power management system to achieve optimization of power flow and management of energy storage to allow efficient use of power to service various loads while preserving energy for high-priority functions, such as the ability to start the engine.

In addition, batteries used in vehicle electrical systems undergo repetitive charge and discharge cycles. A number of charging methodologies are employed for charging the batteries, but they are typically based on a fixed voltage regulation scheme. Some more sophisticated systems monitor battery current to estimate state of charge. However, measurement of charging current alone provides only a limited amount of information regarding the state of the battery. As a result, the batteries are subject to under- or over-charging, reducing the useful life of the batteries. The batteries may also have a shorter discharge cycle than expected, resulting in an inability to operate accessories and/or start the vehicle's engine. There is a need for a vehicle power and battery management system to optimize the flow and management of energy to loads, and to more accurately control and predict battery charge and discharge.

### SUMMARY

A typical vehicle electrical system includes three types of power devices: power sources (e.g., alternator, fuel cell, external power sources), energy storage (e.g., batteries), and loads (e.g., engine starter, lights). By monitoring and controlling power flow between power sources, energy storage devices and loads in a predetermined and prioritized manner there are a number of functions and algorithms that may be implemented to advantage. For example, a predetermined amount of stored energy may be preserved to start the engine. In addition, the starting battery (or batteries or a capacitor in some instances) may be charged preferentially to accessory batteries until a minimum reserve capacity is reached. A monitoring and control system may also provide a warning when standby capacity is close to a predetermined limit, or allow short-term diversion of power for surge loads, such as an AC motor start, by withholding battery charge momentarily, or allowing short-term load support from the batteries.

Loads can be added, subtracted or limited in a predetermined manner in accordance with the power available from the sources. For example, an auxiliary generator or fuel cell can be engaged if depletion of the stored energy is detected, or an AC load limit can be implemented based upon alternator capacity. Likewise, AC load power can be limited automatically if the system alternator is providing less power than is needed, or is not providing any power.

An aspect of the present invention is a vehicle power and battery management system. The system comprises a high-voltage DC bus, a first battery, at least one bidirectional DC/DC converter, and a controller. The controller monitors the state of at least one of the high-voltage bus and the first battery, and transfers energy between the high-voltage bus and first battery with the bidirectional DC/DC converter.

Another aspect of the present invention is a vehicle power and battery management system comprising a high-voltage DC bus, a first battery, a second battery, a first bidirectional DC/DC converter, a second bidirectional DC/DC converter and a controller. The first bidirectional DC/DC converter both receives a high-voltage DC from the high-voltage DC bus and provides a DC voltage to a primary bus, and receives a DC voltage from the primary bus and provides a high-voltage DC voltage to the high-voltage DC bus. A second bidirectional DC/DC converter both receives a DC voltage from the primary bus and provides a DC voltage to a secondary bus, and receives a DC voltage from the secondary bus and provides a DC voltage to the primary bus. The controller monitors the state of at least one of the high-voltage bus, the first battery the second battery, the primary bus and the secondary bus, and then transfers energy between at least two of the high-voltage bus, the first battery the second battery, the primary bus and the secondary bus with at least one of the first and second bidirectional DC/DC converters.

Yet another aspect of the present invention is a method for managing a vehicle's power and charging/discharge of the batteries. The method comprises the steps of providing a high-voltage DC bus, providing a first battery, providing a second battery, monitoring the state of at least one of the high-voltage bus, the first battery and the second battery, and then transferring energy between at least two of the high-voltage bus, the first battery and the second battery to manage at least one of the charge and discharge of at least one of the first and second batteries.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a schematic block diagram of a power management system according to an embodiment of the present invention;

FIG. 2 is a graph indicating battery discharge times for various loads connected to the system of FIG. 1;

FIG. 3 is a surface plot of a battery cell for various times and currents;

FIG. 4 is a flow diagram for controlling the data acquisition rate of a power management system according to an embodiment of the present invention;

FIG. 5 is a Hall effect current transducer usable with an embodiment of the present invention; and

FIG. 6 is a flow diagram for updating an algorithm used by a power management system according to an embodiment of the present invention.

### DETAILED DESCRIPTION

In the discussion that follows and in the accompanying figures, like reference numerals are used to indicate components having substantially the same structure or function. In addition, in the figures, a numeral within a circle indicates a common point of connection for an attached structure or functional block. For example, each component in a figure having a connection to or from an encircled (1) are logically and/or electrically connected together.

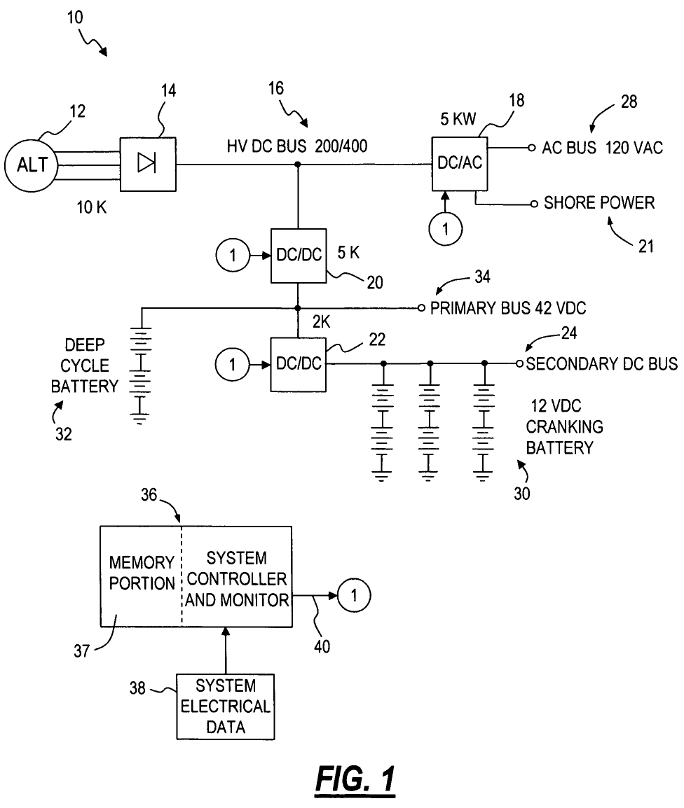

With reference to FIG. 1, a power management system 10 is shown according to an embodiment of the present invention. High-voltage AC generated by an alternator 12 is rectified to DC by a rectifier 14, forming a high voltage DC bus 16. A high voltage is preferable for increased alternator efficiency and for voltage-changing flexibility during subsequent power conversion. A DC/AC inverter 18 receives input power from high voltage bus 16 and converts the DC input power to a predetermined AC voltage and current capacity to power vehicle accessories connected to an AC bus 28. A first DC/DC converter 20 receives input power from high voltage bus 16 and converts the input power to a predetermined DC output voltage and current capacity. The output of converter 20 forms a primary bus 34 in conjunction with a first battery 32 to provide power to devices connected to the primary bus, such as accessories. A second DC/DC converter 22 receives input power from primary bus 34 and converts the input power to a voltage and current output suitable for charging a second battery 30 connected thereto and providing power to secondary bus 24 to power devices connected to the secondary bus, such as a starter for the vehicle's engine.

A system controller and monitor 36 monitors system data 38 relating to the operational status of various portions of system 10, i.e., voltage and current at the various sub-system inputs and outputs, including, but not limited to, alternator 12, high voltage bus 16, primary bus 34, secondary bus 24, AC bus 28, DC/AC converter 18, DC/DC converters 20, 22 and batteries 30, 32. System data 38 may further include data relating to system faults, external commands, and so on. Controller 36 responds to the system data 38 in a predetermined manner to control the operation of inverter 18 and converters 20, 22 to regulate at least one of the voltage and current of at least one of the AC bus 28, primary bus 34 and secondary bus 24, and charge batteries 30, 32. In system 10 a higher-voltage primary bus 34 preferably powers engine accessories while engine cranking power is supplied by a lower-voltage secondary bus 24.

Inverter 18 may directly convert the high voltage DC of bus 16 to a corresponding high voltage AC without the need for a step-up transformer, thus reducing system weight and cost. Inverter 18 must be rated at the full AC output specification since the inverter is the only source of AC power output. For example, if 10 kW of AC output power is required from system 10, inverter 18 must be configured to supply the entire 10 kW. Inverter 18 may be bidirectional and thus additionally capable of converting externally-supplied AC power (i.e., shore power 21) to a high voltage DC and supplying the high voltage DC to bus 16. DC/DC converter 20 may in turn utilize this energy to charge first battery 32 and provide power to primary bus 34. DC/DC converter 22 may likewise utilize the shore power by receiving the power through DC/DC converter 20 to charge second battery 30 and power secondary bus 24. Shore power 21 thus allows operation of power management system 10 during times when power from alternator 12 is unavailable.

DC/DC converter 20 may be bidirectional, thus additionally capable of augmenting alternator 12 by converting power from battery 32 (and/or an external source of power connected to the primary bus 34) to a high voltage compatible with high voltage bus 16 during periods of high load demand on inverter 18. The amount of available additional power supplied to bus 16 by DC/DC converter 20 is limited by the capacity of the DC/DC converter. For example, if a 15 kW inverter 18 is supplied by a 10 kW alternator 12, a 5 kW DC/DC converter 20 is required to supply the additional power needed for the inverter to operate at its full capacity. This configuration also allows at least limited operation of power management system 10 from battery 32 when power is not being provided by alternator 12.

DC/DC converter 22 may also be bidirectional and thus additionally capable of augmenting power available to primary bus 34 by converting power from battery 30 (and/or an external source of power connected to the primary bus) to a voltage compatible with the primary bus and providing the converted voltage to the primary bus. DC/DC converter 22 may also indirectly supply power to high voltage bus 16 through DC/DC converter 20 in the manner previously described, thus supporting operation of inverter 18.

With reference to FIG. 1, with appropriately rated bidirectional DC/DC converters 20, 22, alternator 12 power can be supplied to or from any of high voltage bus 16, primary bus 34 and secondary bus 24. Thus, a high- or low-voltage alternator 12 may be used in system 10. For example, if a high voltage alternator 12 is used, the rectified voltage output from rectifier 14 is connected directly to high voltage bus 16, as shown in FIG. 1. If a low voltage alternator is used, the output of rectifier 14 may be directly connected to primary bus 34. In this configuration, power for inverter 18 is supplied to high voltage bus 16 via bidirectional DC/DC converter 20 in the manner previously described. Alternatively, rectifier 14 may be connected directly to secondary bus 24. In this configuration the power is supplied to primary bus 34 through bidirectional DC/DC converter 22 and, in turn, to high voltage bus 16 through bidirectional DC/DC converter 20.

If there is insufficient power to start the vehicle's prime mover from cranking battery 30, power may be fed into system 10 via multiple buses from an external source, usually another vehicle which typically directly supplies power of a suitable voltage and current to battery 30. Alternatively, AC power from an external source may be fed back into the AC bus 28 or a shore power input 21 of a bidirectional configuration of inverter 18, rectified in the inverter, and routed through DC/DC converters 20, 22 to charge battery 30. If DC/AC inverter 18 and DC/DC converters 20, 22 have sufficient capacity, the external AC power may also be used to start the vehicle's engine.

If DC/DC converter 20 is bidirectional, it can also provide support for alternator 12 when high voltage bus 16 is heavily loaded and further allow operation of system 10 from either or both of batteries 30, 32 if alternator 12 is not providing power. For example, DC/DC converter 20 can be configured to supply additional power from battery 32 to high voltage bus 16 in the manner previously described, to augment power being supplied to the high voltage bus by alternator 12 during periods of heavy high voltage bus loading, thus maintaining the voltage level of the high voltage bus.

Inverter 18 may be unidirectional, i.e., configured to input only a DC voltage and output only an AC voltage. However, if inverter 18 is bidirectional, the inverter can rectify AC power, supplied externally to the inverter through AC bus 28 or shore power 21, to DC and supply the DC power to primary bus 34. Charging of battery 32 may be accomplished through DC/DC converter 20 in the manner previously described. Battery 30 may in turn be charged in the manner previously described through DC/DC converter 22, which is connected to primary bus 34. Thus, when external AC power is connected to inverter 18 the external AC voltage may be rectified by the inverter and supplied to high voltage bus 16 to provide power to DC/DC converters 20, 22 and charge batteries 30, 32 as well as supply power to primary bus 34 and secondary bus 24 in the manner previously described.

In an alternate embodiment of system 10 most high-power accessories are operated from primary bus 34 while secondary bus 24 is used to power relatively low-current devices at a voltage lower than that of the primary bus. In this configuration primary bus 34 may be supported by cranking batteries 30 in place of battery 32, and secondary bus 24 may or may not include a battery, such as a deep cycle battery 32.

In one embodiment controller 36 controls the preferential charging of cranking batteries 30. With appropriately sized bidirectional converters 20, 22 the power from battery 30 can be fed into high voltage bus 16 and/or primary bus 34. Likewise, power from battery 32 may be fed to secondary bus 24 and battery 30 through DC/DC converter 22. Power from battery 32 can also be fed into high voltage bus 16 through DC/DC converter 20. Thus, either of batteries 30, 32 may be preferentially charged from any of the buses 16, 24, 34. Determination of the order in which the batteries are is to be charged, and which buses are to be used for charging, is made by controller 36 in accordance with a predetermined set of criteria. For example, cranking battery 30 may be charged in preference to battery 32, as the cranking battery is necessary to a high-priority function of the vehicle, i.e., starting the vehicle's engine. The criteria may also prioritize or rank charging sources for charging a battery, such as preferentially utilizing high voltage bus 16 to conserve the energy stored in battery 32, but utilizing battery 32 to charge battery 30 if the high voltage bus is unavailable.

If there is insufficient power to start the prime mover, such as a starter for a vehicle engine, power may be fed to system 10 via one or more external sources to supply energy to cranking batteries 30 for starting the prime mover to achieve a jump start. For example, external AC power may be input to bidirectional DC/AC converter 18 through shore power input 21 and rectified to supply high voltage bus 16, primary bus 34 through DC/DC converter 20, and secondary bus 24 through DC/DC converter 22. Alternatively, external DC power of a suitable voltage and current may be directly connected to any or all of batteries 30, 32 and buses 24, 34.

System controller and monitor 36 may be configured to provide a central control and monitoring point for converters 18, 20 and 22. Controller 36 may be any conventional microprocessor, microcomputer, computer, or programmable logic device and may include a predetermined set of instructions, such as a computer program, in a memory portion 37. The instructions allow system 10 to function in the manner described above in accordance with a predetermined set of criteria, rules and algorithms. An output 40 couples controller 36 to converters 18, 20, 22. Output 40 may take any conventional form, such as analog or digital signals, including proprietary and standardized serial and parallel data buses.

System electrical data, shown generally as 38 in FIG. 1, represents a plurality of information status signals provided by the various components of system 10. Example data includes, without limitation, voltages and currents of batteries 30, 32, individual cell voltages and currents for the batteries, temperature levels of converters 18, 20, 22, operational status and fault signals for the converters, operator control input signals. Electrical system data 38 is utilized by controller 36, in conjunction with a computer program portion (not shown), to control operation in a predetermined manner. For example, controller 36 may be configured to preferentially charge one of batteries 30, 32, turn loads on and off in accordance with a predetermined priority, and detect, analyze and compensate for faults and failures.

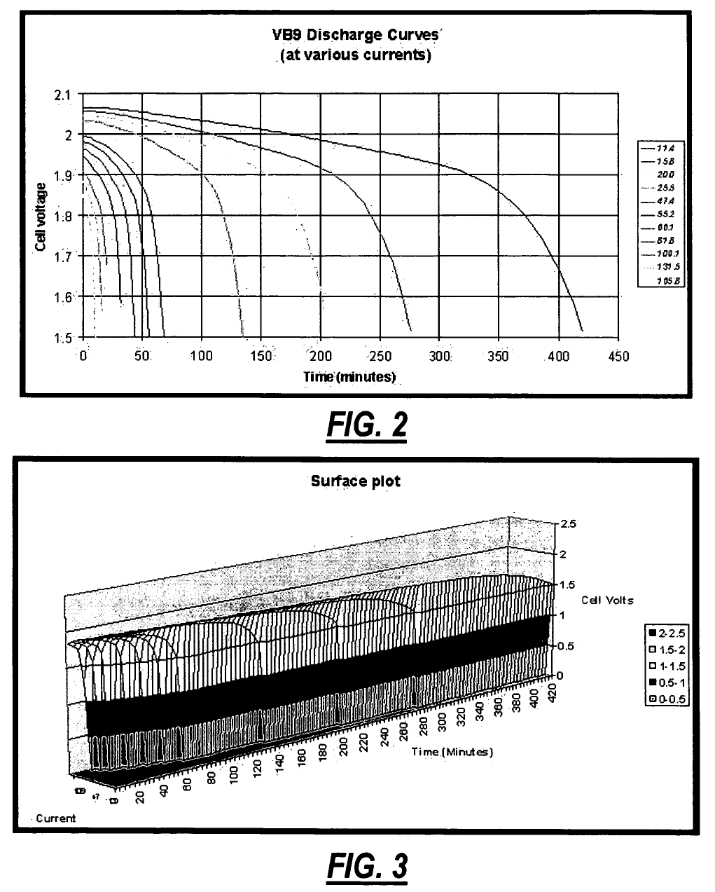

With reference to FIGS. 1, 2 and 3 in combination, batteries 30, 32 are preferably rechargeable batteries. In the battery art, a curve representing the actual discharge of a battery at any moment in time can be generated. By extrapolation to the end of the discharge, such information as: 1) time remaining under the present load; and 2) percentage of battery capacity remaining can be calculated, as well as comprehensive battery performance data, such as maximum power available form the battery and the remaining useful life of the battery. Example discharge curves for a typical sealed lead acid battery are depicted in FIG. 2. Mathematical models may be established based on sets of three-dimensional discharge curves using time, voltage and current as constraints. The models take the form of a series of coefficients for the equations describing the discharge curves. Each model describes an infinite number of curves covering various discharge rates. Temperature correction is added, creating a fourth constraint. It is possible, by monitoring each battery cell during a discharge test, to calculate at any point in time the mean position of the battery as a whole, based on its characteristic three-dimensional surface plot. An example surface plot is illustrated in FIG. 3. Example system conditions include, but are not limited to, battery condition monitoring such as is discussed in U.S. Pat. No. 5,394,089, the entire text of which is hereby incorporated by reference.

Mathematical modeling techniques (termed “virtual cell” herein) can be used to calculate a performance index for the battery. This index provides a reliable and simple-to-use method of measuring the present performance of batteries and predicting the future performance of the batteries. Further, by comparing indices, qualitative judgments can be made regarding the degree of battery aging. Calculation of battery performance indices and standard deviation highlights the fundamental difference between limited battery monitoring, by a simple multi-meter or a similar device, and detailed data collection and analysis form an algorithm to make intelligent deductions and predictions. The algorithm may be incorporated into controller 36 to make decisions about activating alarms and taking emergency action, such as shedding low-priority loads.

The model for each current curve is described by Equation 1:
V=A+Bx+Cx²+Dx³+Ex⁴+Fx⁵ Equation 1
where V is the cell voltage, A-F are discharge coefficients and x is time, typically in minutes.

The performance index (“PI”) of a battery is a measure of a battery's actual performance as compared to a known performance specification, and is expressed by Equation 2:

$$PI = \frac{M + N}{X} \qquad Equation 2$$

where:
M=the actual battery capacity removed from the battery during a given discharge;
N=the calculated remaining capacity of the actual battery using the Virtual Cell during a given discharge; and
X=the nominal ideal capacity specified by the manufacturer (temperature-corrected).

The PI may be recorded every time a discharge occurs and stored in an events log. The stored information can then be used to plot a set of PI figures against discharge dates. The present invention may thus be used to predict battery end-of-life using conventional mathematical and statistical trending and forecasting functions. The present invention does not specify a particular PI as a battery's end of life, as this varies considerably with individual installation and operation. Battery end of life is preferably established in consultation with the battery manufacturer.

When monitoring the starting or “cranking-current” of prime movers such as fuel engines, there are several considerations, such as the predictability of when a cranking event occurs, the environmental effects upon a battery's performance under cranking conditions, the consequential indications of analyzing the desired cranking current waveform, and the impact of electronic monitoring hardware during and after cranking, such as saturation of Hall effect media and processing speed of an associated analyzer and/or monitor.

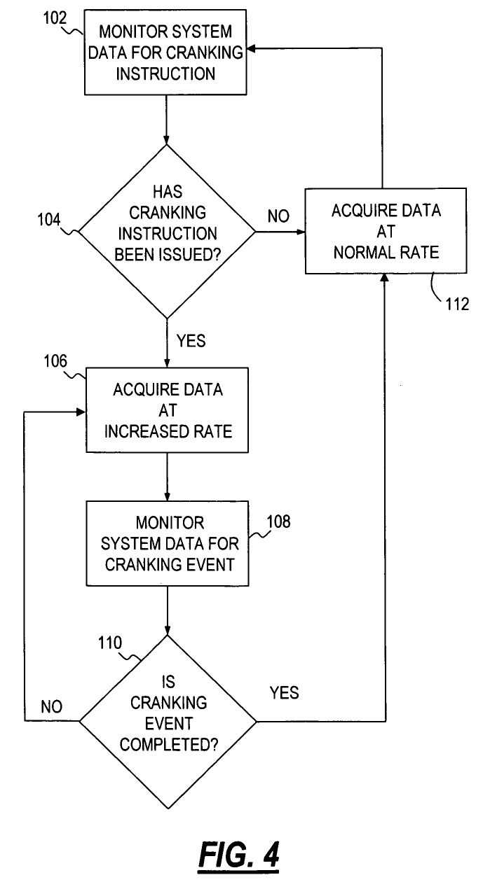

Cranking event predictability is an important issue, as controller 36 is required to attain a higher resolution of discharge over a shorter period of time as compared to conventional stationary battery discharges. There is therefore a higher order of magnitude in the requirement for processing capability of controller 36. However, a problem arises in the response time of controller 36 wherein the controller must have a minimum processing speed capability in order to accurately evaluate a cranking event and ultimately generate meaningful data. This issue may be addressed by adding to controller 36 a data interface such as, for example, a conventional Society of Automotive Engineers (“SAE”) J1939 CANBus interface within controller 36 and programming the I/O processing component as generally shown in FIG. 4. The interface is monitored as at step 102 for an indication that informs the controller 36 that the prime mover has been instructed to crank. Upon acceptance of this data at step 104 the processor commences to operate in a fast-scan mode as at step 106 which increases the sample rate at which voltage and current are logged, such as on the order of kilohertz, and monitors the interface at step 108 until an indication is received at step 110 that the cranking event is completed. At all other times data acquisition occurs at a slower rate, as at step 112.

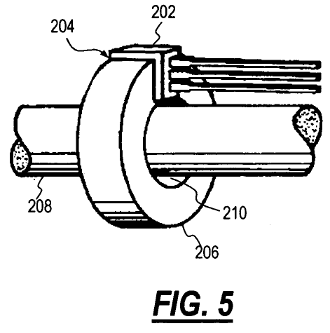

System electrical data 38 may be obtained using transducers to monitor voltages and currents in system 10. During and after a cranking event another problem that must be addressed is the residual flux effect remaining in Hall effect current-monitoring transducers. This issue can be addressed by packaging linear Hall effect integrated circuits with tongued, slotted or gapped ferrite cores, such as the configuration shown in FIG. 5. In FIG. 5 a Hall effect integrated circuit (“IC”) 202 is placed in a gap 204 of a ferrite core 206, which may be generally toroidal, rectangular or any other desired shape. A current-carrying conductor 208 is routed through a central opening 210 of core 206. Magnetic flux around conductor 208, which is generally proportional to the current flowing through the conductor, is coupled to core 206. The magnetic flux in core 206 is sensed by Hall effect IC 202, which outputs an electrical signal that is generally proportional to the magnetic flux and thus the current in conductor 208. This assembly can be embedded in a resin compound to enhance robustness of the components. The resulting performance of a carefully chosen core, preferably a core having low residual flux characteristics, decreases residual polarization of the media to a negligible level and provides the degree of accuracy preferred for monitoring cranking as well as high, low and standby discharge currents.

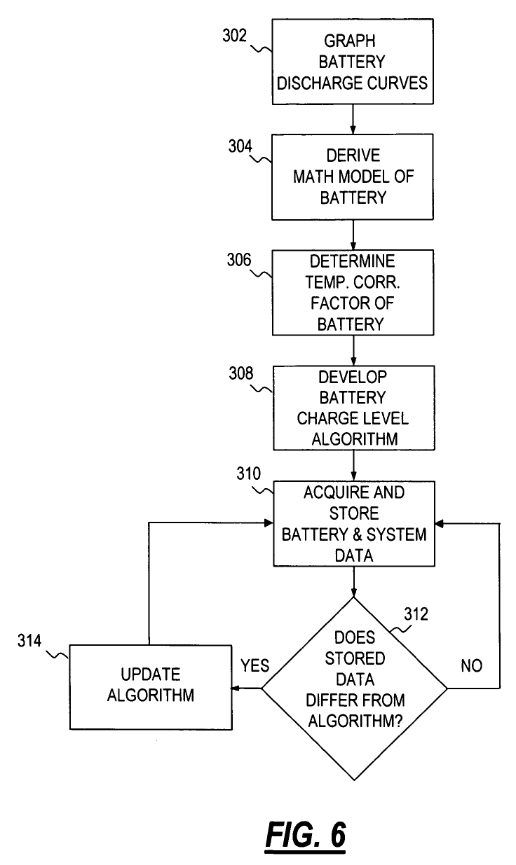

Environmental influences upon battery performance during cranking can be measured and used to tailor the characteristics of the virtual cell algorithm that is resident within controller 36. An example tailoring process is shown in FIG. 6. At step 302 graphical curves representing the actual discharge of the battery at any moment in time can be generated. By extrapolation to the end of the discharge of the battery, such information as: 1) time remaining under the present load; and 2) percentage of battery capacity remaining can be calculated, as well as comprehensive battery performance data. A mathematical model for the battery may be established, as at step 304, based on sets of three-dimensional discharge curves using time, voltage and current as constraints. Each model describes an infinite number of curves covering various discharge rates. Temperature correction factors relating to the battery are determined at step 306 for the expected operating environment for the battery, creating a fourth constraint. It is possible, by monitoring each battery cell of the battery during a discharge test, to generate a charge level algorithm for the battery, as at step 308, to calculate at any point in time the mean position of the battery as a whole, based on its characteristic three-dimensional surface plot. At step 310 the actual environment encountered by the battery while in service, such as minimum temperature, average temperature and maximum temperature, is monitored. The environmental data may be recorded in any conventional manner, such as in a memory portion 37 of controller 36 (FIG. 1). If the data of step 312 differs from the factors of step 306 by a threshold amount, the algorithm is updated at step 314 to tailor and optimize the operation of system 10 for the actual environment seen by the vehicle. By applying these correction and correlation data to prime mover cranking battery 30, it is possible to adjust and calibrate for variations in climactic conditions that the battery must operate in. Thus, the order of accuracy of data to be evaluated has greater validity.

The monitoring and updating steps of FIG. 5 can generally be applied to other parameters of system 10 of FIG. 1. For example, by storage of the cranking waveform within the memory portion 37 of control 36, compiling data logs, and making comparisons to waveforms stored in data tables of the memory portion it is possible to evaluate such criteria as battery cranking performance index. This is similar to the PI discussed above, but performed under cranking conditions. Similarly, trend and forecast battery performance data may be accumulated and analyzed to calculate the probability or a prediction of battery failure based on present and past empirical data. It is also possible to detect alternator problems by continuing to monitor in a fast-scan mode for several seconds after the cranking event has occurred, and evaluating ripple and/or DC voltage and current when the prime mover is operating.

In addition, stored data in memory portion 37 may be utilized to detect battery and starter problems by evaluating voltage and current waveforms during cranking. For example, data for a recent cranking cycle can be compared to previous cycles at various points in the vehicle's history, or trend data may be assembled using the stored data. It is thus possible to identify potential problems by comparison of the waveforms to a data table and to known defective or out-of-tolerance parameters. The foregoing analysis may be accomplished either automatically or manually by controller 36 using instructions from an internally-stored computer program and/or algorithms, by an external computing device such as a personal computer (not shown) adapted to read and analyze data in memory portion 37, and by a human.

Likewise, the present invention may be utilize the stored data of FIG. 5 to formulate a prediction of the likelihood of alternator and/or starter problems or failure. Data of step 310 may be accumulated and plotted in the manner previously discussed to discern trends, make forecasts, and generate probabilities and predictions regarding impending electrical component failures based on empirical past and present data stored in memory portion 37.

The present invention may also be utilized to analyze other vehicle data, such as engine compression, ignition and bearing problems by accumulating in memory portion 37 data to establish trends, make forecasts, and generate probabilities and predictions regarding impending electrical component failure based on empirical past and present data.

Some of the aforementioned data acquisition and analysis tasks require cross reference, communication and event coordination with other prime mover management systems (not shown). Details of coordination between vehicle systems using standardized protocols, networks and interfaces are well-known in the art and thus are left to the artisan.

While this invention has been shown and described with respect to a detailed embodiment thereof, it will be understood by those skilled in the art that various changes in form and detail thereof may be made without departing from the scope of the claims of the invention.

1. A vehicle power and battery management system comprising:
a high-voltage DC bus;
a first battery;
at least one bidirectional DC/DC converter; and
a controller,
wherein the controller monitors the state of at least one of the high-voltage bus and the first battery, and transfers energy between the high-voltage bus and first battery with the bidirectional DC/DC converter.

2. The vehicle power and battery management system of claim 1, further comprising a unidirectional DC/AC inverter that receives a high-voltage DC from the high-voltage DC bus and provides an AC output voltage to an external load.

3. The vehicle power and battery management system of claim 1, further comprising a bidirectional DC/AC inverter that both receives a high-voltage DC from the high-voltage DC bus and provides an AC output voltage to an external load, and receives an AC voltage from an external power source and provides a high-voltage DC to the high-voltage DC bus.

4. The vehicle power and battery management system of claim 1, further comprising a bidirectional DC/DC converter that both receives a high-voltage DC from the high-voltage DC bus and provides a DC voltage to a primary bus, and receives a DC voltage from the primary bus and provides a high-voltage DC voltage to the high-voltage DC bus.

5. The vehicle power and battery management system of claim 1, further comprising a bidirectional DC/DC converter that both receives a DC voltage from a primary bus and provides a DC voltage to a secondary bus, and receives a DC voltage from the secondary bus and provides a DC voltage to the primary bus.

6. The vehicle power and battery management system of claim 1, further comprising a second battery, wherein the controller additionally monitors the state of the second battery, and transfers energy between at least two of the high-voltage bus, first battery and second battery with the bidirectional DC/DC converter.

7. The vehicle power and battery management system of claim 6 wherein the first battery is connected to a primary bus, and wherein the second battery is connected to a secondary bus.

8. The vehicle power and battery management system of claim 6 wherein the controller preferentially charges one of the first and second batteries with the bidirectional DC/DC converter.

9. The vehicle power and battery management system of claim 6 wherein the controller monitors the state of the first and second batteries and disconnects one or more loads from at least one of the first and second batteries to conserve energy.

10. The vehicle power and battery management system of claim 6 wherein the controller monitors and predicts the performance of at least one of the first and second batteries, and adjusts the operation of the bidirectional DC/DC converter in accordance with the state of at least one of the first and second batteries to manage power flow.

11. The vehicle power and battery management system of claim 1 wherein data relating to the system is stored in a memory portion of the controller and is subsequently used to at least one of discern trends, make forecasts, and generate probabilities and predictions regarding impending failures of portions of the system.

12. A vehicle power and battery management system comprising:
a high-voltage DC bus;
a first battery;
a second battery;
a first bidirectional DC/DC converter that both receives a high-voltage DC from the high-voltage DC bus and provides a DC voltage to a primary bus, and receives a DC voltage from the primary bus and provides a high-voltage DC voltage to the high-voltage DC bus;
a second bidirectional DC/DC converter that both receives a DC voltage from the primary bus and provides a DC voltage to a secondary bus, and receives a DC voltage from the secondary bus and provides a DC voltage to the primary bus; and
a controller,
wherein the controller monitors the state of at least one of the high-voltage bus, the first battery the second battery, the primary bus and the secondary bus, and transfers energy between at least two of the high-voltage bus, the first battery the second battery, the primary bus and the secondary bus with at least one of the first and second bidirectional DC/DC converters.

13. The vehicle power and battery management system of claim 12 wherein the primary bus is a higher DC voltage than the secondary bus.

14. The vehicle power and battery management system of claim 12 wherein the first battery is connected to the primary bus and the second battery is connected to the secondary bus.

15. The vehicle power and battery management system of claim 12 wherein the secondary bus supplies the primary bus through the second bidirectional DC/DC converter.

16. The vehicle power and battery management system of claim 12 wherein the primary bus supplies the secondary bus through the second bidirectional DC/DC converter.

17. The vehicle power and battery management system of claim 12 wherein the high-voltage DC bus supplies at least one of the primary and secondary buses through at least one of the first and second bidirectional DC/DC converters.

18. The vehicle power and battery management system of claim 12 wherein at least one of the primary and secondary buses supply the high-voltage DC bus through at least one of the first and second bidirectional DC/DC converters.

19. The vehicle power and battery management system of claim 12, further comprising a unidirectional DC/AC inverter that receives a high-voltage DC from the high-voltage DC bus and provides an AC output voltage to an external load.

20. The vehicle power and battery management system of claim 12, further comprising a bidirectional DC/AC inverter that both receives a high-voltage DC from the high-voltage DC bus and provides an AC output voltage to an external load, and receives an AC voltage from an external power source and provides a high-voltage DC to the high-voltage DC bus.

21. The vehicle power and battery management system of claim 12 wherein data relating to the system is stored in a memory portion of the controller and is subsequently used to at least one of discern trends, make forecasts, and generate probabilities and predictions regarding impending failures of portions of the system.

22. A method for managing a vehicle's power and batteries, comprising the steps of:
providing a high-voltage DC bus;
providing a first battery;
monitoring the state of at least one of the high-voltage bus and the first battery, and transferring energy between the high-voltage bus and the first battery to manage at least one of the charge and discharge of the battery.

23. The method of claim 22, further comprising the steps of providing a second battery, monitoring the state of the second battery, and transferring energy between at least two of the high-voltage bus, first battery and second battery.

24. The method of claim 22, further comprising the step of preferentially charging one of the first and second batteries.

25. The method of claim 22, further comprising the steps of monitoring the state of the first and second batteries and disconnecting one or more loads from at least one of the first and second batteries to conserve energy.

26. The method of claim 22, further comprising the steps of monitoring and predicting the performance of at least one of the first and second batteries, and adjusting the power flow from at least one of the first and second batteries in accordance with the state of at least one of the first and second batteries.
